(19) United States
(12) Patent Application Publication
(10) Pub. No.: US 2024/0394058 A1
(43) Pub. Date: Nov. 28, 2024

(54) ENHANCED TECHNIQUES FOR AVOIDING DOUBLE CLOSURES OF FILE DESCRIPTORS

(71) Applicant: Sandpiper CDN, LLC, Wilmington, DE (US)

(72) Inventor: William CROWDER, Camarillo, CA (US)

(73) Assignee: Sandpiper CDN, LLC, Wilmington, DE (US)

(21) Appl. No.: 18/442,008

(22) Filed: Feb. 14, 2024

Related U.S. Application Data
(60) Provisional application No. 63/504,705, filed on May 26, 2023.

(51) Int. Cl. G06F 9/30; G06F 9/54

(52) U.S. Cl. CPC G06F 9/3005; G06F 9/545

(57) ABSTRACT

This disclosure describes systems, methods, and devices related to preventing multiple closures of a file descriptor. A method may include identifying a close( ) system call requesting closure of a file descriptor that is opened to a first file; generating, based on the close( ) system call, prior to closing the file descriptor, a dup2( ) system call for the file descriptor; releasing, based on the dup2( ) system call, the first file from the file descriptor; opening, based on the dup2( ) system call, the file descriptor to a second file; determining that a threshold delay from receipt of the close( ) system call has expired; and closing, based on the expiration of the threshold delay, the file descriptor.

### CROSS-REFERENCE TO RELATED APPLICATION

This application is related to and claims priority under 35 U.S.C. § 119 (e) from U.S. Patent Application No. 63/504,705, filed May 26, 2023, titled “ENHANCED TECHNIQUES FOR AVOIDING DOUBLE CLOSURES OF FILE DESCRIPTORS,” the entire content of which is incorporated herein by reference for all purposes.

### TECHNICAL FIELD

Embodiments of the present invention generally relate to devices, systems, and methods for enhanced techniques for avoiding double closures of file descriptors.

### BACKGROUND

When a file descriptor is closed, it may be reassigned to another computer resource. Some situations may allow for a file descriptor to be closed multiple times, resulting in subsequent problems.

### SUMMARY

A method of preventing multiple closures of a file descriptor, the method comprising: identifying, by at least one processor of a device, a close( ) system call requesting closure of a file descriptor that is opened to a first file; generating, by the at least one processor, based on the close( ) system call, prior to closing the file descriptor, a dup2( ) system call for the file descriptor; releasing, by the at least one processor, based on the dup2( ) system call, the first file from the file descriptor; opening, by the at least one processor, based on the dup2( ) system call, the file descriptor to a second file; determining, by the at least one processor, that a threshold delay from receipt of the close( ) system call has expired; and closing, by the at least one processor, based on the expiration of the threshold delay, the file descriptor.

A device for preventing multiple closures of a file descriptor, the device comprising memory coupled to at least one processor, wherein the at least one processor is configured to: identify a close( ) system call requesting closure of a file descriptor that is opened to a first file; generate, based on the close( ) system call, prior to closing the file descriptor, a dup2( ) system call for the file descriptor; release, based on the dup2( ) system call, the first file from the file descriptor; open, by the at least one processor, based on the dup2( ) system call, the file descriptor to a second file; determine, by the at least one processor, that a threshold delay from receipt of the close( ) system call has expired; and close, by the at least one processor, based on the expiration of the threshold delay, the file descriptor.

A system for preventing multiple closures of a file descriptor, the system comprising: at least one processor coupled to memory, the at least one processor configured to: identify a close( ) system call requesting closure of a file descriptor that is opened to a first file; generate, based on the close( ) system call, prior to closing the file descriptor, a dup2( ) system call for the file descriptor; release, based on the dup2( ) system call, the first file from the file descriptor; open, by the at least one processor, based on the dup2( ) system call, the file descriptor to a second file; determine, by the at least one processor, that a threshold delay from receipt of the close( ) system call has expired; and close, by the at least one processor, based on the expiration of the threshold delay, the file descriptor.

### BRIEF DESCRIPTION OF THE DRAWINGS

FIG. 1 illustrates an exemplary process for using file descriptors in accordance with one embodiment.

FIG. 2 illustrates an example process preventing multiple closures of a file descriptor in accordance with one embodiment.

FIG. 3 is a flowchart illustrating a process for preventing multiple closures of a file descriptor in accordance with one embodiment.

FIG. 4 is a diagram illustrating an example of a computing system that may be used in implementing embodiments of the present disclosure.

### DETAILED DESCRIPTION

Aspects of the present disclosure involve devices, systems, methods, and the like, for enhanced techniques for avoiding double closures of file descriptors.

Files and other data resources have a non-negative integer that identifies them (referred to as a file descriptor), describing the data resource and how the data resource may be accessed. A file descriptor provides a way for a kernel to access a computer resource. When a program requests to open a file or other data resource, such as a network socket, the kernel may grant access, create an entry in a global file table, and provide modules with the location of the entry. When a process makes a successful request to open a file or other resource, the kernel returns a file descriptor, which points to an entry in the kernel's global file table, which may include information such as the resource's index node, byte offset, and access restrictions such as read-only, write-only, and the like. The file descriptor is an identifier given to a kernel to communicate to the kernel on which file to operate.

A close( ) call (e.g., system call) may cause a kernel to release and close a file descriptor so that the closed file descriptor no longer refers to any file and may be reused. A single process may be limited to a finite number of file descriptors. It is therefore beneficial to close a file descriptor no longer in use by an application so that the number of the file descriptor may be reused by another process. The kernel allocates the lowest unused file descriptor when a new descriptor is created, allowing for closed file descriptors to be reused quickly after closure. Because of this quick reuse, a significant bug may occur in which a file descriptor is closed twice.

In some double closures, the second closure would fail, but in some double closures the following detrimental situation may occur. The file descriptor is closed (e.g., using close( )). A new outgoing connection is opened and is assigned the file descriptor that was just closed (e.g., referred to as Thread A). The file descriptor is then closed again due to the bug, while Thread A still operates as if the connection is open. Another new outgoing connection is opened and assigned the same file descriptor that was just closed (e.g., referred to as Thread B). Thread A and Thread B then share the same file descriptor. Thread B writes a HTTP request on the connection. Thread B writes a HTTP request on the same connection. Thread A reads the HTTP response on the connection as if it were the response to the HTTP request from Thread A, but the response is the HTTP response to the HTTP request from Thread B, so the wrong object is served to Thread A and cached. Because the kernel uses the lowest numbered file descriptor that is not already open, Thread A and Thread B may share the same file descriptor when a double closure bug occurs.

In one or more embodiments, to avoid the double closure bug for file descriptors, a close( ) system call may be hooked (e.g., intercepted) using a shared object and LD_PRELOAD (e.g., a list of shared objects to be loaded before others). When a file descriptor is closed using close( ), the hook may use a dup2( ) system call to duplicate a file descriptor onto it that may be open on an innocuous file (e.g.,/dev/null). The result is closure of the file descriptor, thereby releasing the resources associated with the file descriptor, and immediate and atomic reopening of the file descriptor due to the dup2( ) call, preventing reassignment of the file descriptor by the kernel. A dup2( ) call performs the same task as the dup( ) system call that allocates a new file descriptor referring to the same open file description as the oldfd descriptor (e.g., dup(int oldfd)), but instead of using a the lowest numbered available file descriptor, dup2( ) uses the new file descriptor number newfd that is specified (e.g., dup2(int oldfd, in newfd)). The dup2( ) call atomically closes and reuses the file descriptor, preventing the file descriptor from being reused by the kernel. In this manner, the dup2( ) call duplicates the closed file descriptor so that the kernel identifies the file descriptor as still open and unavailable for reassignment. Due to the finite number of file descriptors available, at some point the duplicate file descriptor may be closed and made available for reassignment, but a delay from the close( ) call to the actual closure of the duplicate file descriptor may be implemented to ensure that the file descriptor closed with the close( ) call is not reassigned too quickly. The delay may be a threshold amount of time or a threshold number of received dup2( ) system calls (e.g., hooked to close( ) calls) for file descriptors after which the duplicate file descriptor may be closed.

In one or more embodiments, the file descriptor reclamation process may proceed in a least-recently-used manner so that the oldest closed file descriptor may be reclaimed and made available for reassignment. The delay may be proportional to the rate at which new file descriptors are required and the number of file descriptors the system supports. The value of the protection may be proportional to how long a closed file descriptor may be prevented from being reused. Because the hook may track closed file descriptors, the hook also may detect and diagnose double closures.

The above descriptions are for purposes of illustration and are not meant to be limiting. Numerous other examples, configurations, processes, etc., may exist, some of which are described in greater detail below. Example embodiments will now be described with reference to the accompanying figures.

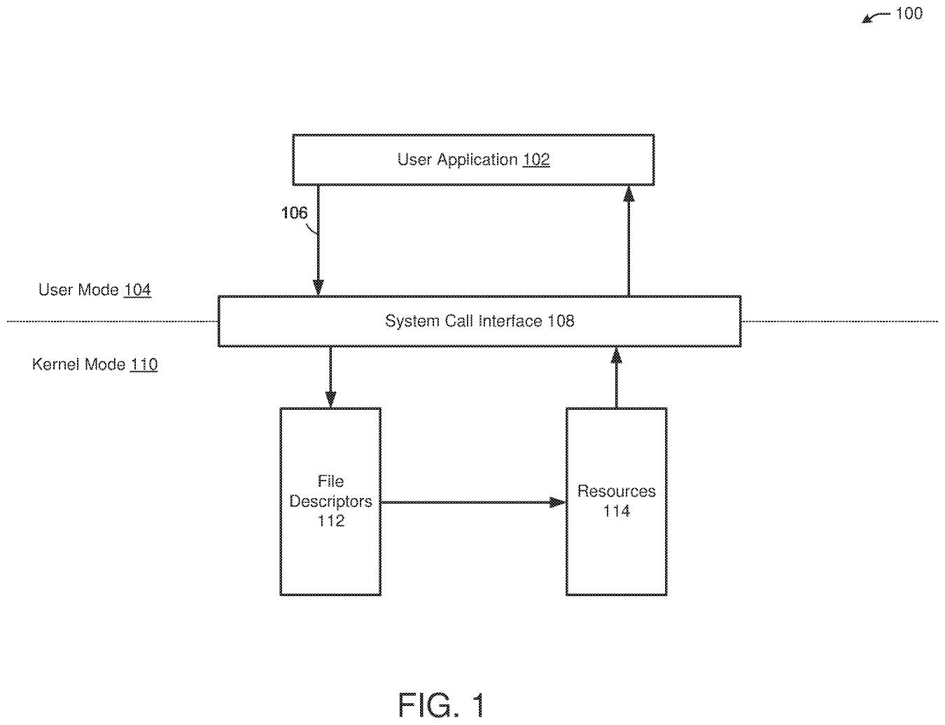

FIG. 1 illustrates an exemplary process 100 for using file descriptors in accordance with one embodiment.

Referring to FIG. 1, the process 100 may include a user application 102 in a user mode 104 making system calls 106 (e.g., open( ), close( ), read( ), write( ), etc.) to a system call interface 108 between the user mode 104 and a kernel mode 110. The system call interface 108 may copy the data from the system calls 106 into the kernel mode 110 for use. For example, when the system calls 106 include an open( ) call, a file descriptor from a table of file descriptors 112 may be opened and assigned a resource (e.g., of the resources 114) for use by the user application 102. However, as noted above, when the system calls 106 include multiple close( ) calls, a file descriptor to be closed by the close( ) calls may be closed two or more times, which may result in an incorrect object being served to a thread reading from a connection corresponding to the file descriptor (e.g., because the file descriptor may end up shared by multiple threads).

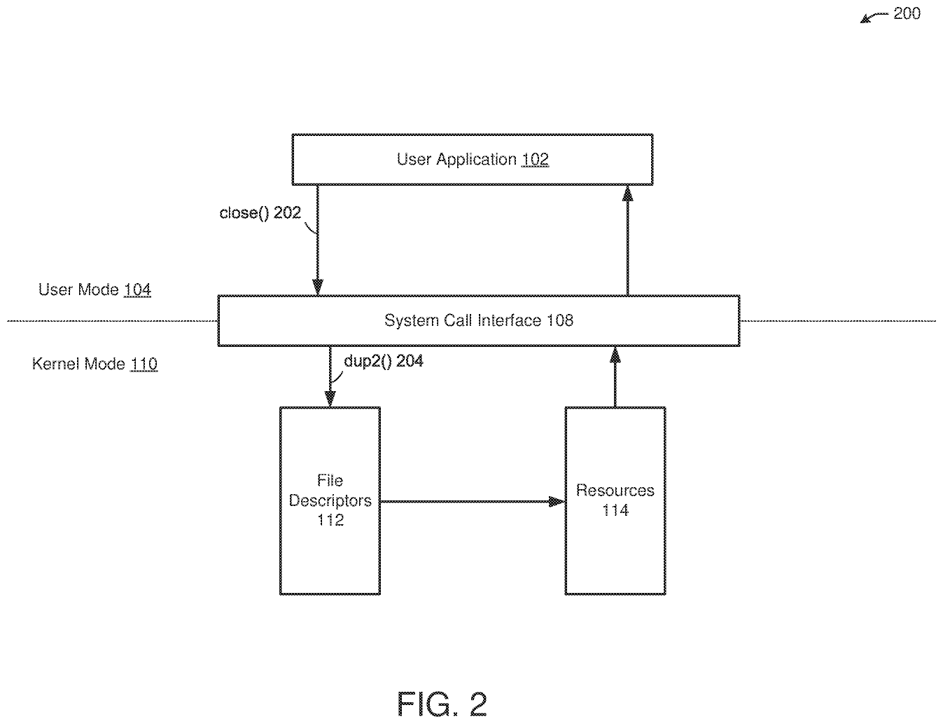

FIG. 2 illustrates an example process 200 preventing multiple closures of a file descriptor in accordance with one embodiment.

Referring to FIG. 2, the user application 102 of FIG. 1 may make a close( ) system call 202 as one of its system calls 106. However, instead of immediately closing a file descriptor based on the close( ) system call 202, the system call interface 108 may hook the close( ) system call 202 with a dup2( ) system call 204. The dup2( ) system call 204 may duplicate a file descriptor onto it that may be open on an innocuous file (e.g.,/dev/null) of the resources 114. The result is closure of the file descriptor, thereby releasing the resources associated with the file descriptor, and immediate and atomic reopening of the file descriptor due to the dup2( ) system call 204, preventing reassignment of the file descriptor by the kernel. The dup2( ) system call 204 atomically closes and reuses the file descriptor, preventing the file descriptor from being reused by the kernel. In this manner, the dup2( ) system call 204 duplicates the closed file descriptor so that the kernel identifies the file descriptor as still open and unavailable for reassignment.

In one or more embodiments, due to the finite number of file descriptors available, at some point the duplicate file descriptor may be closed and made available for reassignment, but a delay from the close( ) system call 202 to the actual closure of the duplicate file descriptor may be implemented to ensure that the file descriptor closed with the close( ) system call 202 is not reassigned too quickly. The delay may be a threshold amount of time or a threshold number of received dup2( ) system calls (e.g., hooked to close( ) calls) for file descriptors after which the duplicate file descriptor may be closed.

In one or more embodiments, the file descriptor reclamation process may proceed in a least-recently-used manner so that the oldest closed file descriptor may be reclaimed and made available for reassignment. The delay may be proportional to the rate at which new file descriptors are required and the number of file descriptors the system supports. The value of the protection may be proportional to how long a closed file descriptor may be prevented from being reused. Because the hook may track closed file descriptors, the hook also may detect and diagnose double closures.

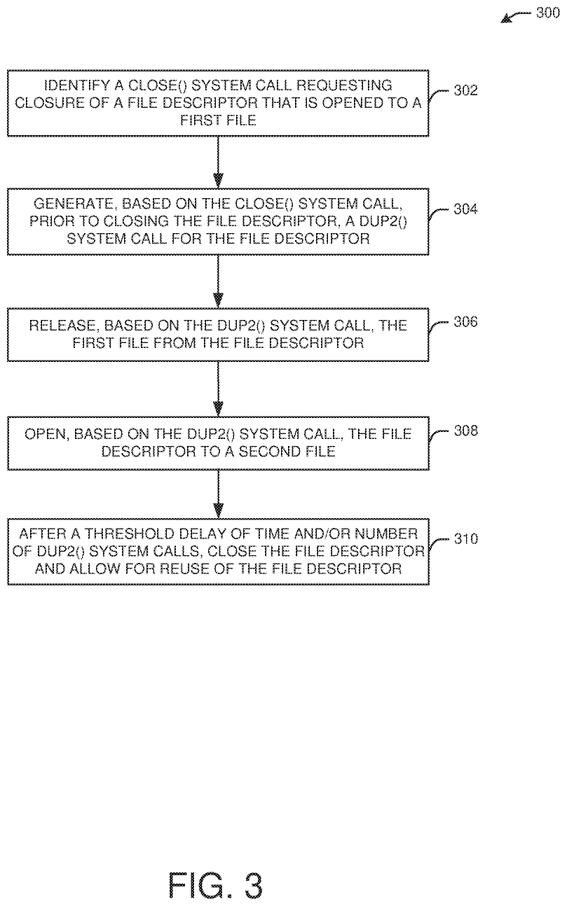

FIG. 3 is a flowchart illustrating a process 300 for preventing multiple closures of a file descriptor in accordance with one embodiment.

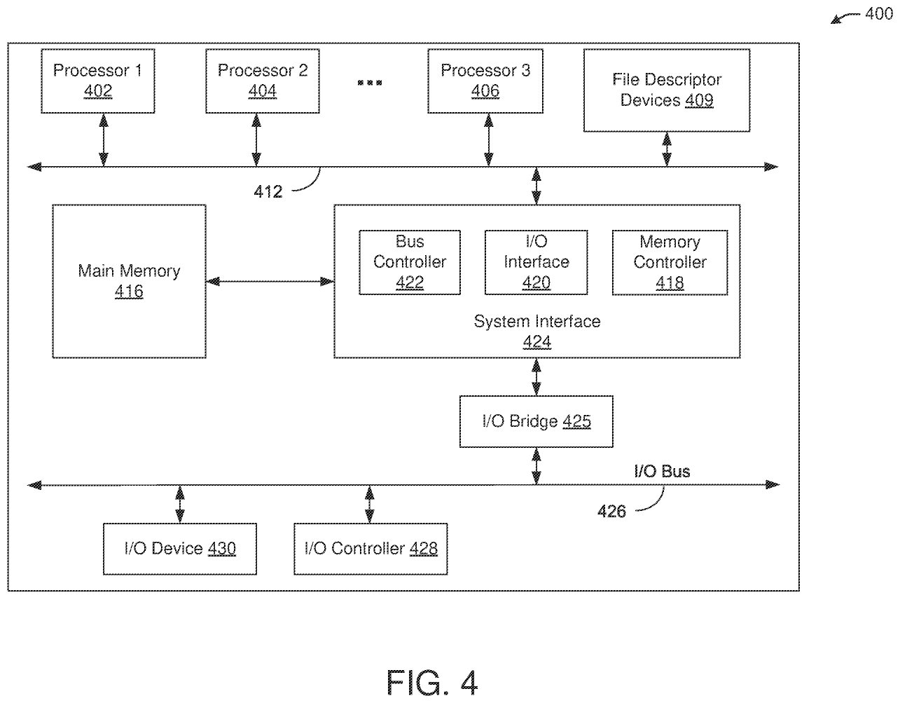

At block 302, a device (or system, e.g., the system call interface 108, the file descriptor devices 409 of FIG. 4) may identify a close( ) system call (e.g., the close( ) system call 202 of FIG. 2) requesting closure of a file descriptor that is opened to a first file.

At block 304, the device may hook the close( ) system call and generate, based on the close( ) system call, prior to closing the file descriptor, a dup2( ) system call (e.g., the dup2( ) system call 204 of FIG. 2) for the file descriptor.

At block 306, based on the dup2( ) system call, the device may release the first file from the file descriptor, and at block 308, based on the dup2( ) system call, may open the file descriptor to a second file (e.g., an innocuous file like a/dev/null file).

At block 308, after a threshold delay, the device may close the file descriptor and allow it to be reused. Due to the finite number of file descriptors available, at some point the duplicate file descriptor may be closed and made available for reassignment, but a delay from the close( ) call to the actual closure of the duplicate file descriptor may be implemented to ensure that the file descriptor closed with the close( ) call is not reassigned too quickly. The delay may be a threshold amount of time or a threshold number of received dup2( ) system calls (e.g., hooked to close( ) calls) for file descriptors after which the duplicate file descriptor may be closed. The file descriptor reclamation process may proceed in a least-recently-used manner so that the oldest closed file descriptor may be reclaimed and made available for reassignment. The delay may be proportional to the rate at which new file descriptors are required and the number of file descriptors the system supports. The value of the protection may be proportional to how long a closed file descriptor may be prevented from being reused. Because the hook may track closed file descriptors, the hook also may detect and diagnose double closures.

It is understood that the above descriptions are for purposes of illustration and are not meant to be limiting.

FIG. 4 is a block diagram illustrating an example of a computing device or computer system 400 which may be used in implementing the embodiments of the components of the network disclosed above. For example, the computing system 400 of FIG. 4 may represent at least a portion of the user mode 104 and/or the kernel mode 110 of FIG. 1, and discussed above. The computer system (system) includes one or more processors 402-406 and one or more file descriptor devices 409 (e.g., capable of performing any operations described with respect to FIGS. 1-3). Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method of preventing multiple closures of a file descriptor, the method comprising:
identifying, by at least one processor of a device, a close( ) system call requesting closure of a file descriptor that is opened to a first file;
generating, by the at least one processor, based on the close( ) system call, prior to closing the file descriptor, a dup2( ) system call for the file descriptor;
releasing, by the at least one processor, based on the dup2( ) system call, the first file from the file descriptor;
opening, by the at least one processor, based on the dup2( ) system call, the file descriptor to a second file;
determining, by the at least one processor, that a threshold delay from receipt of the close( ) system call has expired; and
closing, by the at least one processor, based on the expiration of the threshold delay, the file descriptor.

2. The method of claim 1, wherein the threshold delay is a threshold amount of time.

3. The method of claim 1, wherein the threshold delay is a number of dup2( ) system calls generated in response to close( ) system calls.

4. The method of claim 3, further comprising:
receiving a second close( ) system call requesting closure of a second file descriptor;
generating, based on the second close( ) system call, prior to closing the second file descriptor, a second dup2( ) system call for the second file descriptor;
wherein determining that the threshold delay from the receipt of the close( ) system call has expired comprises determining that a sum of dup2( ) system calls, comprising the dup2( ) system call and the second dup2( ) system call, exceeds the threshold delay.

5. The method of claim 1, wherein the file is a /dev/null file.

6. The method of claim 1, wherein the threshold delay is proportional to a rate at which new file descriptors are required and a number of supported file descriptors comprising the file descriptor.

7. The method of claim 1, further comprising:
determining that the file descriptor is the least-recently-used file descriptor among recently-used file descriptors that have been duplicated using dup2( ) system calls,
wherein closing the file descriptor is further based on the file descriptor being the least-recently-used file descriptor.

8. A device for preventing multiple closures of a file descriptor, the device comprising memory coupled to at least one processor, wherein the at least one processor is configured to:
identify a close( ) system call requesting closure of a file descriptor that is opened to a first file;
generate, based on the close( ) system call, prior to closing the file descriptor, a dup2( ) system call for the file descriptor;
release, based on the dup2( ) system call, the first file from the file descriptor;
open, by the at least one processor, based on the dup2( ) system call, the file descriptor to a second file;
determine, by the at least one processor, that a threshold delay from receipt of the close( ) system call has expired; and
close, by the at least one processor, based on the expiration of the threshold delay, the file descriptor.

9. The device of claim 8, wherein the threshold delay is a threshold amount of time.

10. The device of claim 8, wherein the threshold delay is a number of dup2( ) system calls generated in response to close( ) system calls.

11. The device of claim 10, wherein the at least one processor is further configured to:
receive a second close( ) system call requesting closure of a second file descriptor;
generate, based on the second close( ) system call, prior to closing the second file descriptor, a second dup2( ) system call for the second file descriptor;
wherein to determine that the threshold delay from the receipt of the close( ) system call has expired comprises to determine that a sum of dup2( ) system calls, comprising the dup2( ) system call and the second dup2( ) system call, exceeds the threshold delay.

12. The device of claim 8, wherein the file is a /dev/null file.

13. The device of claim 8, wherein the threshold delay is proportional to a rate at which new file descriptors are required and a number of supported file descriptors comprising the file descriptor.

14. The device of claim 8, wherein the at least one processor is further configured to:
determine that the file descriptor is the least-recently-used file descriptor among recently-used file descriptors that have been duplicated using dup2( ) system calls, wherein to close the file descriptor is further based on the file descriptor being the least-recently-used file descriptor.

15. A system for preventing multiple closures of a file descriptor, the system comprising:
at least one processor coupled to memory, the at least one processor configured to:
identify a close( ) system call requesting closure of a file descriptor that is opened to a first file;
generate, based on the close( ) system call, prior to closing the file descriptor, a dup2( ) system call for the file descriptor;
release, based on the dup2( ) system call, the first file from the file descriptor;
open, by the at least one processor, based on the dup2( ) system call, the file descriptor to a second file;
determine, by the at least one processor, that a threshold delay from receipt of the close( ) system call has expired; and
close, by the at least one processor, based on the expiration of the threshold delay, the file descriptor.

16. The system of claim 15, wherein the threshold delay is a threshold amount of time.

17. The system of claim 15, wherein the threshold delay is a number of dup2( ) system calls generated in response to close( ) system calls.

18. The system of claim 17, wherein the at least one processor is further configured to:
receive a second close( ) system call requesting closure of a second file descriptor;
generate, based on the second close( ) system call, prior to closing the second file descriptor, a second dup2( ) system call for the second file descriptor;
wherein to determine that the threshold delay from the receipt of the close( ) system call has expired comprises to determine that a sum of dup2( ) system calls, comprising the dup2( ) system call and the second dup2( ) system call, exceeds the threshold delay.

19. The system of claim 15, wherein the file is a/dev/null file.

20. The system of claim 15, wherein the threshold delay is proportional to a rate at which new file descriptors are required and a number of supported file descriptors comprising the file descriptor.
